(19) United States
(12) Patent Application Publication
(10) Pub. No.: US 2008/0084633 A1
(43) Pub. Date: Apr. 10, 2008

(54) Information recording media, method of manufacturing the information recording media, read/write head, and method of manufacturing the read/write head

(75) Inventors: Hyun-jei Kim, Yongin-si (KR); Yong-su Kim, Yongin-si (KR); Hoon-sang Oh, Yongin-si (KR); Hoo-san Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/729,852

(22) Filed: Mar. 30, 2007

(30) Foreign Application Priority Data
Oct. 9, 2006 (KR) 10-2006-0098142

(51) Int. Cl. G11B 5/74

(52) U.S. Cl. 360/131; 360/110

(57) ABSTRACT

An information recording medium, a method of manufacturing the information recording medium, a read/write head, and a method of manufacturing the read/write head are provided. The information recording medium includes magnetic recording layers formed of a ferromagnetic substance and electrical recording layers formed of a ferroelectric substance. The read/write head includes an electromagnetic write head including a main pole, a return pole magnetically connected to the main pole but electrically isolated from the main pole, a magnetic field applicator which applies a magnetic field to the main pole, and a voltage source which applies a bias voltage to the main pole; a magnetic read head provided an a side of the electromagnetic write head; and an electrical read head provided on an other side of the electromagnetic write head.

### CROSS-REFERENCE TO RELATED PATENT APPLICATIONS

This application claims priority from Korean Patent Application No. 10-2006-0098142, filed on Oct. 9, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to an information recording medium and a read/write head and, more particularly, to an information recording medium and a read/write head capable of improving a recording density.

2. Description of the Related Art

Hard disk drives (HDDs) are mainly used as main storage devices of computers. In HDDS, read/write heads fly over rotating recording medium so as to read and/or write information. Such an HDD generally uses a magnetic recording method. In other words, an HDD forms a plurality of magnetic domains, which are magnetized in a first direction and a reverse direction (a second direction) to the first direction, within a magnetic recording medium using a magnetic field. Here, the magnetic domains magnetized in the first and second directions may correspond to “0” and “1,” respectively.

Research on the improvement of recording densities of HDDs has been briskly made with a sudden increase in the information used by users. Discrete track recording (DTR) technology has attracted attention as technology for improving recording densities of HDDs. The DTR technology is suggested in the field of optical disk drives (ODDs) and characterized by forming a groove as an insulation region between tracks (recording regions) of a recording medium.

FIG. 1 is a partial perspective view of a DTR medium (hereinafter referred to as a conventional DTR medium 100) disclosed in U.S. Pat. No. 7,019,924. Referring to FIG. 1, the conventional DTR medium 100 includes tracks 20. Grooves 15 are formed between the tracks 20. Reference numeral 10 denotes a substrate.

If a DTR medium having such a structure is applied to an HDD, a magnetic interference phenomenon between tracks may be reduced to realize higher track and recording densities.

However, the above-described conventional DTR medium has the following problems.

Since groove regions are not used as recording regions, the improvement of a recording density is limited. Physical discreteness between tracks is a principle of improving the recording density. However, grooves formed for the physical discreteness cause losses of the recording regions.

Also, since a surface of the conventional DTR medium is uneven, a read/write head may unstably lift from the conventional DTR medium.

In addition, a diamond-like carbon (DLC) layer and a lubricant layer may not be satisfactorily coated due to the grooves.

It is difficult to apply the conventional DTR medium to an HDD system due the above-described problems. Also, although the DTR medium is applied to the HDD system, it is difficult to realize ultrahigh density recording.

### SUMMARY OF THE INVENTION

Exemplary embodiments of the present invention provide an information recording medium enabling high density recording without losses of recording regions and preventing an unstable lift of a head, a method of manufacturing the information recording medium, a read/write head used for the information recording medium, and a method of manufacturing the read/write head.

According to an aspect of the present invention, there is provided an information recording medium including magnetic recording layers formed of a ferromagnetic substance and electrical recording layers formed of a ferroelectric substance.

The magnetic and electrical recording layers may be ring type tracks.

The magnetic and electrical recording layers may be alternately disposed.

The magnetic recording layers may be formed on protrusions of a substrate, and the electrical recording layers may be formed in grooves formed between the protrusions.

The electrical recording layers may be formed on protrusions of a substrate, and the magnetic recording layers may be formed in grooves formed between the protrusions.

According to another aspect of the present invention, there is also provided a method of manufacturing an information recording medium, including: forming first recording layers patterned on a substrate; and forming second recording layers beside the first recording layers.

The first recording layers may be magnetic recording layers, and the second recording layers may be electrical recording layers.

The first recording layers may be electrical recording layers, and the second recording layers may be magnetic recording layers.

The formation of the first recording layers may include: forming grooves and protrusions in the substrate; forming the first recording layers on the protrusions.

The formation of the second recording layers may include: forming the second recording layers to fill the grooves and cover the first recording layers; and performing chemical mechanical polishing (CMP) on the second recording layers until the first recording layers are exposed.

The grooves and the protrusions may be formed using a nano-imprint process.

A depth of the grooves may be within a range between 5 nm and 50 nm.

A thickness of the first recording layers may be within a range between 5 nm and 50 nm.

According to another aspect of the present invention, there is also provided an electromagnetic write head including: a main pole; a return pole magnetically connected to the main pole but electrically isolated from the main pole; a magnetic field applicator which applies a magnetic field to the main pole; and a voltage source which applies a bias voltage to the main pole.

An electrical barrier layer may be provided between upper parts of the main pole and the return pole.

A thickness of the electrical barrier layer may be within a range between 10 nm and 2 μm.

The electrical barrier layer may be a soft magnetic layer.

The soft magnetic layer may be an oxide-based soft magnetic layer.

According to another aspect of the present invention, there is also provided an electromagnetic read/write head including: an electromagnetic write head including a main pole, a return pole magnetically connected to the main pole but electrically isolated from the main pole, a magnetic field applicator which applies a magnetic field to the main pole, and a voltage source which applies a bias voltage to the main pole; a magnetic read head provided on a side of the electromagnetic write head; and an electrical read head provided on an other side of the electromagnetic write head.

A shield may be provided between the electromagnetic write head and the magnetic read head.

The electrical read head may be a field effect transistor structure.

The electrical read head may include: a source region and a drain region formed in a substrate to be spaced apart from each other; a resistance region formed between the source region and the drain region; and first and second electrodes respectively adhered onto the source region and the drain region.

According to another aspect of the present invention, there is also provided a method of manufacturing an electromagnetic read/write head, including: forming a magnetic read head and an electromagnetic write head on a first substrate and an electrical read head on a second substrate; and adhering the first substrate comprising the magnetic read head and the electromagnetic write head to the second substrate comprising the electrical read head.

The first substrate may be an AlTiC substrate.

The second substrate may be a Si substrate.

The electromagnetic write head may include: a main pole; a return pole magnetically connected to the main pole but electrically isolated from the main pole; a magnetic field applicator which applies a magnetic field to the main pole; and a voltage source which applies a bias voltage to the main pole.

The electrical read head may include: source and drain regions formed in the second substrate to be spaced apart from each other; a resistance region formed between the source and drain regions; and first and second electrodes respectively adhered onto the source and drain regions.

### BRIEF DESCRIPTION OF THE DRAWINGS

The above and other features and advantages of the present invention will become more apparent by describing in detail exemplary embodiments thereof with reference to the attached drawings, in which:

FIG. 1 is a partial perspective view of a conventional information recording medium;

FIG. 2 is a plan view of an information recording medium according to an exemplary embodiment of the present invention;

FIGS. 3A through 3E are cross-sectional views illustrating a method of manufacturing an information recording medium according to an exemplary embodiment of the present invention;

FIG. 4 is a cross-sectional view illustrating an electrical/magnetic read/write head and an information recording medium according to an exemplary embodiment of the present invention;

FIG. 5 is a perspective view of an electrical read head (ERH) used in an electrical/magnetic read/write head according to an exemplary embodiment of the present invention; and

FIG. 6 is a plan view illustrating main parts of a medium facing surface of an electrical/magnetic read/write head according to an exemplary embodiment of the present invention.

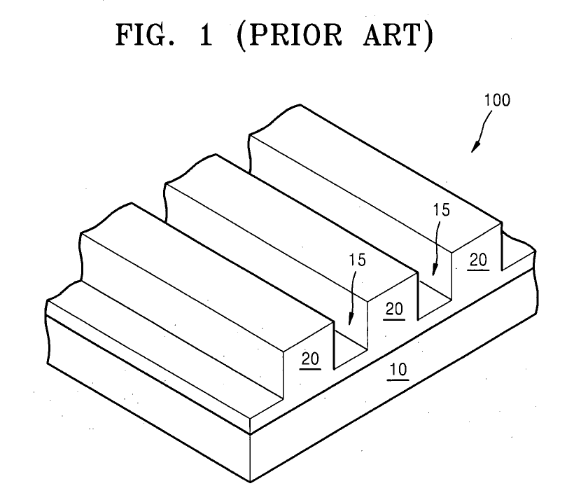

### DETAILED DESCRIPTION OF EXEMPLARY EMBODIMENTS OF THE INVENTION

Hereinafter, an information recording medium, a method of manufacturing the information recording medium, a read/write head, and a method of manufacturing the read/write head will be described in detail with reference to the attached drawings. In the drawings, the thicknesses of layers and regions are exaggerated for clarity. Like reference numerals and marks in the drawings denote like elements, and thus their description will be omitted.

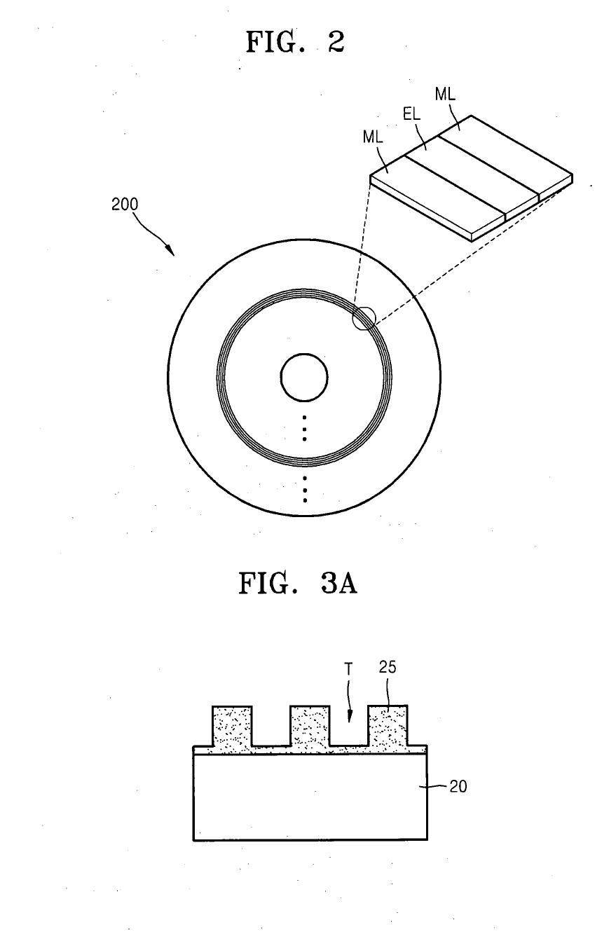

FIG. 2 is a plan view of an information recording medium 200 according to an exemplary embodiment of the present invention. FIG. 2 also illustrates a partially enlarged perspective view of the information recording medium 200.

Referring to FIG. 2, the information recording medium 200 includes magnetic recording layers ML formed of a ferromagnetic substance and electrical recording layers EL formed of a ferroelectric substance. The magnetic anisotropic energy of the ferromagnetic substance may be 1×10⁶ erg/cm³ or more, and the dielectric constant of the ferroelectric substance may be 300 or less.

Here, the magnetic recording layers ML and the electrical recording layers EL may be ring type tracks formed on a surface of a disk type medium. The magnetic recording layers ML and the electrical recording layers EL may be alternatively disposed at least two times.

The magnetic recording layers ML may be formed on protrusions of a substrate, and the electrical recording layers EL may be formed within grooves formed between the protrusions. Alternatively, the electrical recording layers EL may be formed on the protrusions of the substrate, and magnetic recording layers ML may be formed within the grooves formed between the protrusions.

As described above, in the information recording medium 200 according to the present embodiment, electrical recording tracks fill spaces between magnetic recording tracks, or the magnetic recording tracks fill spaces between the electrical recording tracks. Thus, the discreteness between tracks is maintained without losses of recording regions, and a surface of the information recording medium 200 is planar.

A method of manufacturing an information recording medium according to an exemplary embodiment of the present invention will now be described.

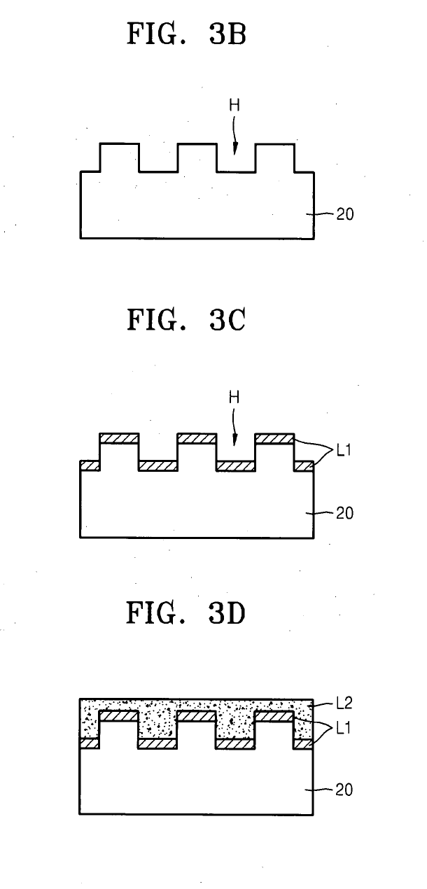

FIGS. 3A through 3E are cross-sectional views illustrating a method of manufacturing an information recording medium according to an exemplary embodiment of the present invention. Referring to FIG. 3A, a resin layer is coated on a substrate 20 and then patterned using a nano-imprint process. Thus, a resin layer pattern 25 having an uneven shape may be formed. Relatively thin resin layers remain on bottoms of spaces between convex parts of the resin layer pattern 25, i.e., trenches T.

Here, the nano-imprinting process includes manufacturing a master stamp using nano-patterning including electron beam lithography, coating a resin layer such as a photoresist layer on a substrate, and imprinting the resin layer with the master stamp to pattern the resin layer on a nano-scale. Such nano-imprint process is simple and economical and thus suitable for mass-production.

Regions of the substrate 20 corresponding to the trenches T may be electrical recording reserved regions, and regions of the substrate 20 corresponding to the convex parts may be magnetic recording reserved regions. Alternatively, the regions of the substrate 20 corresponding to the trenches T may be the magnetic recording reserved regions, and the regions of the substrate 20 corresponding to the convex parts may be the electrical recording reserved regions.

Referring to FIG. 3B, the substrate 20 is etched using the resin layer pattern 25 as an etching mask. The etching may be reactive ion etching (RIE). As a result, grooves H are formed in parts of the substrate 20 corresponding to the trenches T, and protrusions are formed between the grooves H. A depth of the grooves H may be within a range between 5 nm and 50 nm. Widths of the grooves H and the protrusions may be each 100 nm or less or may be equal to each other. The grooves H may be electrical recording reserved regions or magnetic recording reserved regions.

The resin layer pattern 25 remaining after the etching is removed by plasma ashing, wet cleaning, etc.

Referring to FIG. 3C, first recording layers L1 are formed on the protrusions of the substrate 20. A thickness of the first recording layers L1 may be within a range between 5 nm and 50 nm. Here, the first recording layers L1 may be formed on bottoms of the grooves H. The first recording layers L1 may be magnetic recording layers formed of a ferromagnetic substance or electrical recording layers formed of a ferroelectric substance. If the first recording layers L1 are the magnetic recording layers, the first recording layers L1 may be formed using a vapor deposition process or a plating process. If the first recording layers L1 are the electrical recording layers, the first recording layers L1 may be formed using the vapor deposition process.

Referring to FIG. 3D, a second recording layer L2 is formed to fill the grooves H and cover the first recording layers L1. If the first recording layers L1 are the magnetic recording layers, the second recording layer L2 may be an electrical recording layer. If the first recording layers L1 are the electrical recording layers, the second recording layer L2 may be a magnetic recording layer. The second recording layer L2 is sufficiently thick, and thus the first recording layers L1 underneath the second recording layer L2 do not function as substantial recording regions. If the second recording layer L2 is the electrical recording layer, the second recording layer L2 may be formed using a vapor deposition process. If the second recording layer L2 is the magnetic recording layer, the second recording layer L2 may be formed using the vapor deposition process or a plating process.

Referring to FIG. 3E, the second recording layer L2 is polished using chemical mechanical polishing (CMP) until the first recording layers L1 are exposed.

Such an information recording medium of the present invention includes electrical recording tracks and magnetic recording tracks and has a planar surface, wherein the electrical recording tracks and the magnetic recording tracks are discrete.

A read/write head used for an information recording medium according to an exemplary embodiment of the present invention will now be described.

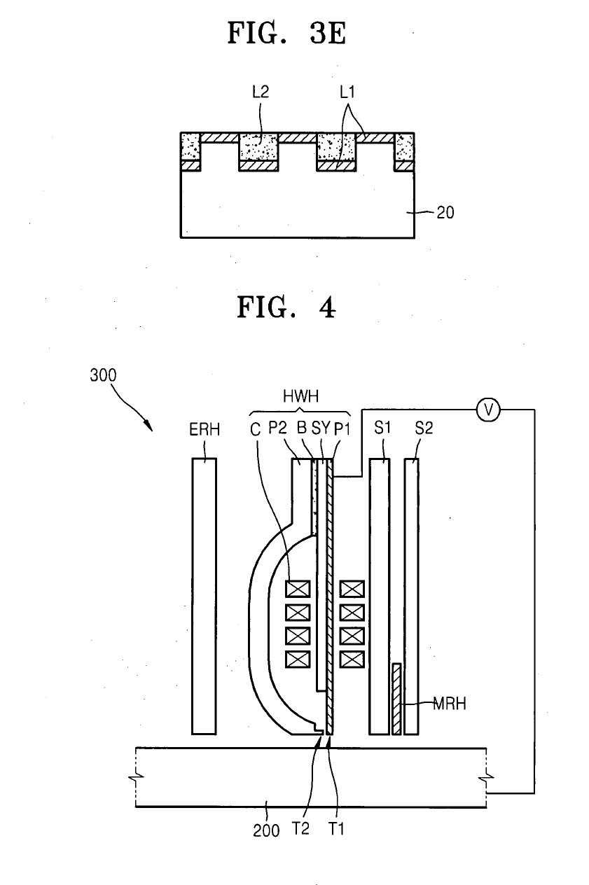

FIG. 4 is a cross-sectional view illustrating an electrical/magnetic read/write head (hereinafter referred to as an electromagnetic read/write head) and an information recording medium according to an exemplary embodiment of the present invention. Referring to FIG. 4, an electromagnetic read/write head 300 includes an electromagnetic write head (HWH), a magnetic read head (MRH), and an electrical read head (ERH). Reference numeral 200 denotes the information recording medium of the present invention which has been described above.

The HWH according to the present embodiment will now be described

The HWH includes a main pole P1 and a return pole P2. Here, the return pole P2 is magnetically connected to the main pole P1 but electrically isolated from the main pole P1.

An electrical barrier layer B may be interposed between upper parts of the main pole P1 and the return pole P2 and have a thickness between 10 nm and 2 μm. The electrical barrier layer B may be a soft magnetic layer. The soft magnetic layer may be formed of an oxide-based material such as ferrite.

Although not shown, a space between the upper parts of the main pole P1 and the return pole P2 may be empty. The empty space between the upper parts of the main pole P1 and the return pole P2, i.e., an air gap may have a thickness of 10 nm or more. The air gap is a kind of dielectric layer and may perform a similar function to the soft magnetic layer. However, if the air gap is used, much magnetic loss may occur.

A sub yoke (SY) may be adhered to the main pole P1 to be interposed between the main pole P1 and the electrical barrier layer B and contribute to forming a magnetic path. A position of the SY may vary. For example, the SY may be adhered to a right side of the main pole P1.

A coil C may be interposed between intermediate parts of the main pole P1 and the return pole P2 to apply a magnetic field to the main pole P1. The coil C may enclose the main pole P1.

End parts T1 and T2 of the main pole P1 and the return pole P2 may be positioned between the coil C and the information recording medium 200 to be spaced apart from each other.

When the HWH is positioned on a magnetic recording layer, and a current flows in the coil C, a magnetic path is formed between the end part T1 of the main pole P1 and the end part T2 of the return pole P2 and the information recording medium 200 to achieve magnetic recording.

The main pole P1 is connected to a voltage source V which applies a bias voltage. The voltage source V may also be connected to the information recording medium 200 to induce a potential difference between the main pole P1 and the information recording medium 200.

If the potential difference is induced between the main pole P1 and the information recording medium 200 through the voltage source V in a state that the HWH is positioned on an electrical recording layer and a current does not flow in the coil C, electrical recording is achieved. The electrical barrier layer B prevents the bias voltage from being applied to the return pole P2.

The MRH and the ERH will now be described.

The MRH is provided on a side of the HWH and may be a giant magneto resistance (GMR) head or a tunnel magneto resistance (TMR) head. First and second shields S1 and S2 may be respectively provided on opposite sides of the MRH.

The first shield S1 and the return pole P2 positioned on opposite sides of the main pole P1 operate as electrical shields during the electrical recording. Thus, efficiency of a writing work is improved. In detail, when an electrical signal is written to the electrical recording layer, a width of a boundary region between bits, i.e., a transition region, is reduced due to the electrical shields.

The ERH is provided on the other side of the HWH.

The ERH may be a planar type field effect transistor (FFT) structure. The ERH will be described in more detail below.

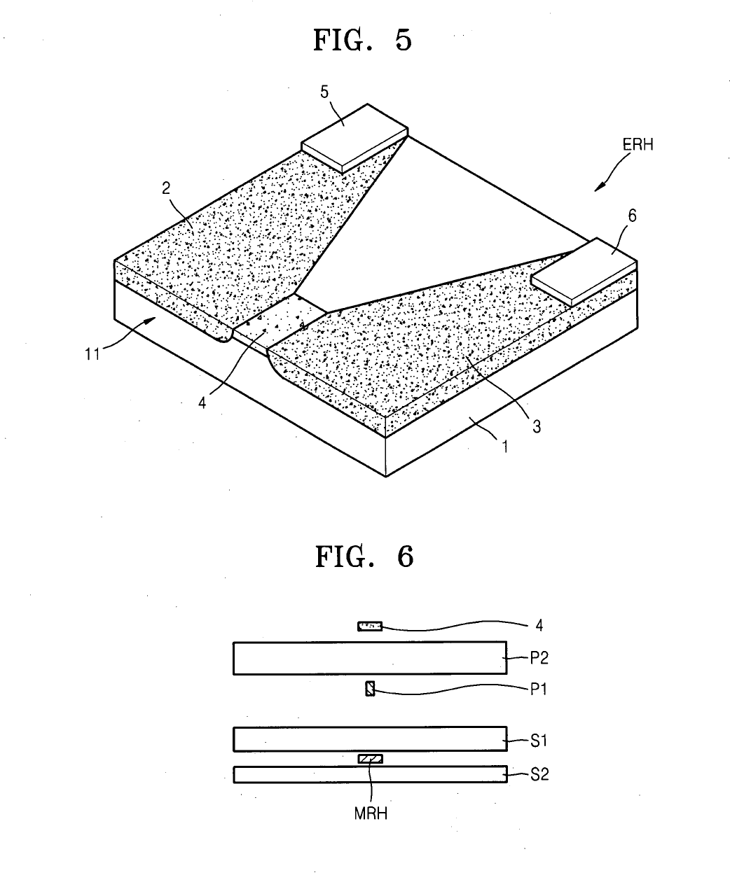

FIG. 5 is a perspective view of an ERH used in an electromagnetic read/write head according to an exemplary embodiment of the present invention. Referring to FIG. 5, the ERH includes a source region 2 and a drain region 3 which are formed in a surface of a substrate 1 to be spaced apart from each other. The source and drain regions 2 and 3 are high density doped regions. A resistance region 4 is formed as a low density doped region between portions of the source and drain regions 2 and 3. The resistance region 4 is formed to be exposed to a medium facing surface 11. First and second electrodes 5 and 6 are respectively adhered onto the source and drain regions 2 and 3.

Variations of a resistance of the resistance region 4 and a current magnitude between the source and drain regions 2 and 3 is a principle of electrical reading.

The structure of the ERH may be modified. For example, the source and drain regions 2 and 3 are exposed to the medium facing surface 11 in the present embodiment of FIG. 5 but may be formed in the substrate 1 so as not to be exposed to the medium facing medium 11.

FIG. 6 is a plan view illustrating main parts of a medium facing surface of an electromagnetic read/write head according to an exemplary embodiment of the present invention.

Like reference numerals and marks in FIGS. 4, 5, and 6 denote like elements.

An HWH and an MRH may be formed together above a substrate, while an ERH may be separately formed above a different substrate and then adhered to the HWH. The HWH and the MRH may be formed above an AlTiC substrate, and the ERH may be formed above an Si substrate.

As described above, in an information recording medium consistent with the present invention, magnetic recording regions and electrical recording regions are alternately disposed. Thus, tracks are maintained discrete without losses of recording regions. As a result, a recording density can be greatly improved.

Also, since a surface of the information recording medium is planar, a read/write head can stably lift from the information recording medium. Also, a DLC layer and a lubricant layer can be uniformly coated. Therefore, the information recording medium of the present invention can be easily applied to an HDD system.

In addition, the return pole P2 and the first shield S1 can operate as electrical shields during electrical recording using an electromagnetic recording head of the present invention. Thus, a width of a transition region is reduced. As a result, an electrical recording density can be increased.

Moreover, servo patterns can be formed only on magnetic recording layers and then used during reading and/or writing magnetic and electrical signals. Thus, different servo patterns do not need to be formed on electrical recording layers. As a result, the recording density can be further improved.

Furthermore, a writing work can be performed using a method of writing information to a magnetic recording layer and transiting the information from the magnetic recording layers to an electrical recording layer. Thus, lowering of a recording speed occurring during applying of an electrical recording method to an HDD can be addressed.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An information recording medium comprising magnetic recording layers formed of a ferromagnetic substance and electrical recording layers formed of a ferroelectric substance.

2. The information recording medium 1, wherein the magnetic and electrical recording layers are ring type tracks.

3. The information recording medium of claim 1, wherein the magnetic and electrical recording layers are alternately disposed.

4. The information recording medium of claim 3, wherein the magnetic recording layers are formed on protrusions of a substrate, and the electrical recording layers are formed in grooves formed between the protrusions.

5. The information recording medium of claim 3, wherein the electrical recording layers are formed on protrusions of a substrate, and the magnetic recording layers are formed in grooves formed between the protrusions.

6. A method of manufacturing an information recording medium, comprising:
forming first recording layers patterned on a substrate; and
forming second recording layers beside the first recording layers.

7. The method of claim 6, wherein the first recording layers are magnetic recording layers, and the second recording layers are electrical recording layers.

8. The method of claim 6, wherein the first recording layers are electrical recording layers, and the second recording layers are magnetic recording layers.

9. The method of claim 6, wherein the formation of the first recording layers comprises:
forming grooves and protrusions in the substrate;
forming the first recording layers on the protrusions.

10. The method of claim 9, wherein the formation of the second recording layers comprises:
forming the second recording layers to fill the grooves and cover the first recording layers; and
performing chemical mechanical polishing (CMP) on the second recording layers until the first recording layers are exposed.

11. The method of claim 9, wherein the grooves and the protrusions are formed using a nano-imprint process.

12. The method of claim 9, wherein a depth of the grooves is within a range between 5 nm and 50 nm.

13. The method of claim 6, wherein a thickness of the first recording layers is within a range between 5 nm and 50 nm.

14. An electromagnetic write head comprising:
a main pole;
a return pole magnetically connected to the main pole but electrically isolated from the main pole;
a magnetic field applicator which applies a magnetic field to the main pole; and
a voltage source which applies a bias voltage to the main pole.

15. The electromagnetic write head of claim 14, wherein an electrical barrier layer is provided between upper parts of the main pole and the return pole.

16. The electromagnetic write head of claim 15, wherein a thickness of the electrical barrier layer is within a range between 10 nm and 2 μm.

17. The electromagnetic write head of claim 15, wherein the electrical barrier layer is a soft magnetic layer.

18. The electromagnetic write head of claim 17, wherein the soft magnetic layer is an oxide-based soft magnetic layer.

19. An electromagnetic read/write head comprising:
an electromagnetic write head comprising a main pole, a return pole magnetically connected to the main pole but electrically isolated from the main pole, a magnetic field applicator which applies a magnetic field to the main pole, and a voltage source which applies a bias voltage to the main pole;
a magnetic read head provided on a side of the electromagnetic write head; and
an electrical read head provided on an other side of the electromagnetic write head.

20. The electromagnetic read/write head of claim 19, wherein a shield is provided between the electromagnetic write head and the magnetic read head.

21. The electromagnetic read/write head of claim 19, wherein the electrical read head is a field effect transistor structure.

22. The electromagnetic read/write head of claim 19, wherein the electrical read head comprises:
a source region and a drain region formed in a substrate to be spaced apart from each other;
a resistance region formed between the source region and the drain region; and
first and second electrodes respectively adhered onto the source region and the drain region.

23. A method of manufacturing an electromagnetic read/write head, comprising:
forming a magnetic read head and an electromagnetic write head on a first substrate and an electrical read head on a second substrate; and
adhering the first substrate comprising the magnetic read head and the electromagnetic write head to the second substrate comprising the electrical read head.

24. The method of claim 23, wherein the first substrate is an AlTiC substrate.

25. The method of claim 23, wherein the second substrate is an Si substrate.

26. The method of claim 23, wherein the electromagnetic write head comprises:
a main pole;
a return pole magnetically connected to the main pole but electrically isolated from the main pole;
a magnetic field applicator which applies a magnetic field to the main pole; and
a voltage source which applies a bias voltage to the main pole.

27. The method of claim 23, wherein the electrical read head comprises:
a source region and a drain region formed in the second substrate to be spaced apart from each other;
a resistance region formed between the source region and the drain region; and
first and second electrodes respectively adhered onto the source region and the drain region.
